(19) United States
(12) Patent Application Publication
(10) Pub. No.: US 2006/0152630 A1
(43) Pub. Date: Jul. 13, 2006

(54) Video signal processor, video signal processing method, and TV broadcasting receiving set

(76) Inventor: Hirotoshi Miyazawa, Kumagaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/303,951

(22) Filed: Dec. 19, 2005

(30) Foreign Application Priority Data
Dec. 20, 2004 (JP) 2004-368211

(51) Int. Cl. G06K 9/40; H04N 5/21

(52) U.S. Cl. 348/606; 348/622; 382/266

(57) ABSTRACT

The present invention comprises a coring value generator unit configured to generate a coring value in accordance with changes, a contour correction signal generator unit which generates contour correction signals by calculating the quadratic differential signals from the video signals, carrying out nonlinear processing including restricting amplitudes, coring and gain adjustment for the calculated quadratic differential signals and is configured to carry out the coring by the coring value from the coring value generator unit, and an output unit configured to add the contour correction signals generated by the contour correction signal generator unit to the video signals and output the added signals.

### CROSS-REFERENCE TO RELATED APPLICATIONS

This application is based upon and claims the benefit of priority from prior Japanese Patent Application No. 2004-368211, filed Dec. 20, 2004, the entire contents of which are incorporated herein by reference.

### BACKGROUND OF THE INVENTION

1. Field of the Invention

The present invention relates to a video signal processor, video signal processing method, and TV broadcasting receiver in which influences of ringing component are removed when contour correction signals are generated.

2. Description of the Related Art

As commonly known, for example, in TV receivers and digital versatile disk (DVD) recorders and other TV broadcasting receiving sets, the TV broadcasting signals received are demodulated to obtain video signals, while signals obtained by quadratically differentiating this video signal are used as contour correction signals and added to original video signals in order to carry out contour correction of video pictures. In the following description, signal processing primarily for horizontal contour correction will be discussed.

For conventional horizontal contour correction circuits, for example, as disclosed in Jpn. Pat. Appln. KOKAI Publication No. 10-164396 or U.S. Pat. No. 6,148,116 specifications, a method and a circuit for adaptively correcting the contour component of luminance signals are proposed, which can perform coring by the coring values set in accordance with the noise components detected from inputted luminance signals.

However, each of these publications provides a contour component correction method and a correction circuit for adaptively correcting contour in accordance with video characteristics by carrying out coring for contour components by the coring value set in accordance with the noise components of luminance signals inputted and no consideration was given to the ringing components which are generated at the rising portion of video signal waveform in a video signal processing circuit.

### BRIEF SUMMARY OF THE INVENTION

According to one aspect of the present invention, there is provided a video signal processor comprising: a ringing detector unit configured to detect ringing components of video signals inputted; a coring value generator unit configured to generate a coring value in accordance with changes of ringing components detected at the ringing detector unit; a contour correction signal generator unit which generates contour correction signals by calculating quadratic differential signals from the video signals inputted, carrying out nonlinear processing including restricting amplitudes, coring and gain adjustment to the calculated quadratic differential signals and is configured to carry out the coring by the coring value from the coring value generator unit; and an output unit configured to output the contour correction signals generated in the contour correction signal generator unit by adding them to the video signals inputted.

According to one aspect of the present invention, there is provided a video signal processing method, comprising: a ringing detection step of detecting ringing components of video signals inputted; a coring value generation step of generating a coring value in accordance with the ringing components detected; a contour correction signal generating step of generating contour correction signals by calculating quadratic differential signals from the video signals inputted, carrying out nonlinear processing including restricting amplitudes, coring and gain adjustment for the calculated quadratic differential signals the coring being carried out by the coring value generated in the coring value generating step; and an output step of adding the contour correction signal generated to the video signals inputted and outputting the added signals.

According to one aspect of the present invention, there is provided a TV broadcasting receiving unit comprising: a receiver unit configured to receive TV broadcasting and demodulate it to video signals; a ringing detector unit configured to detect ringing components of video signals obtained by the receiver unit; a coring value generator unit configured to generate a coring value in accordance with changes in ringing components detected by the ringing detector unit; a contour correction signal generator unit which generates contour correction signals by calculating the quadratic differential signals from the video signals obtained by the receiver unit, and carrying out nonlinear processing including restricting amplitudes, coring and gain adjustment for the calculated quadratic differential signals and is configured to carry out the coring by the coring value from the coring value generator unit; an output unit configured to add the contour correction signals generated by the contour correction signal generator unit to the video signals obtained by the receiver unit and output the added signals; and a display unit configured to display video signals outputted from the output unit.

### BRIEF DESCRIPTION OF THE SEVERAL VIEWS OF THE DRAWING

FIG. 1 is a block diagram that shows a video signal processor of one embodiment according to the present invention;

FIGS. 2A to 2C are illustrations that explains the action of the processor of FIG. 1;

FIG. 3 is a ringing waveform drawing;

FIG. 4 is an illustration that explains the action of the coring circuit in the processor of FIG. 1;

FIG. 5 is a flow chart when a system equivalent to FIG. 1 is achieved by software;

FIG. 6 is a block diagram that shows a TV broadcasting receiver to which a video signal processor according to the present invention is applied; and

FIG. 7 is a block diagram that shows a configuration of the video signal processor in FIG. 6.

### DETAILED DESCRIPTION OF THE INVENTION

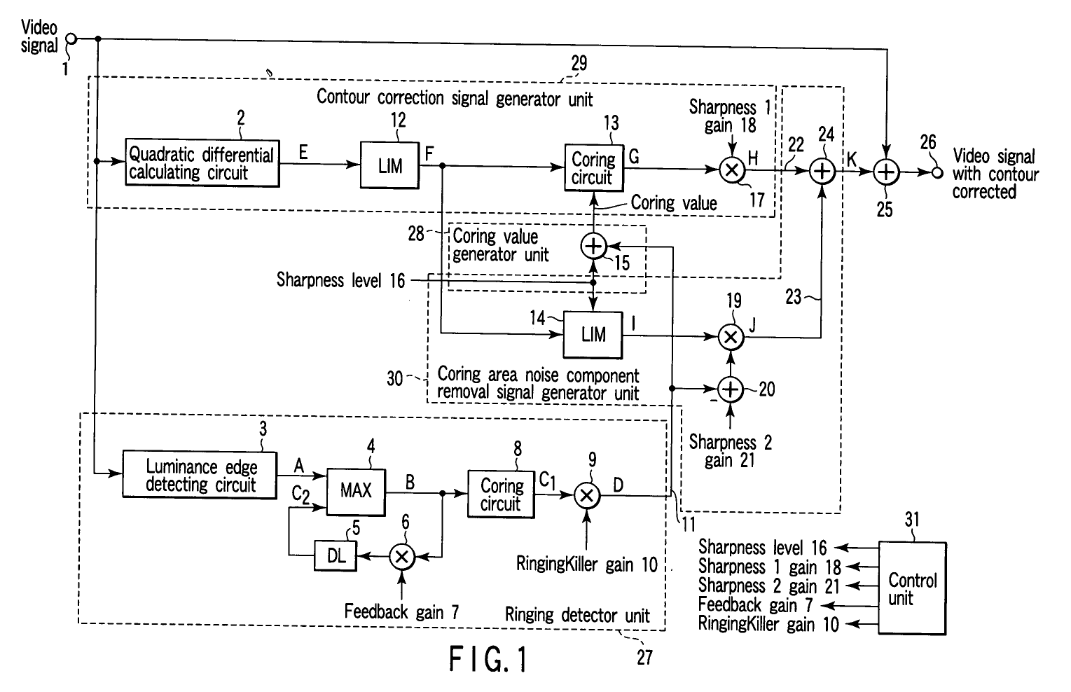

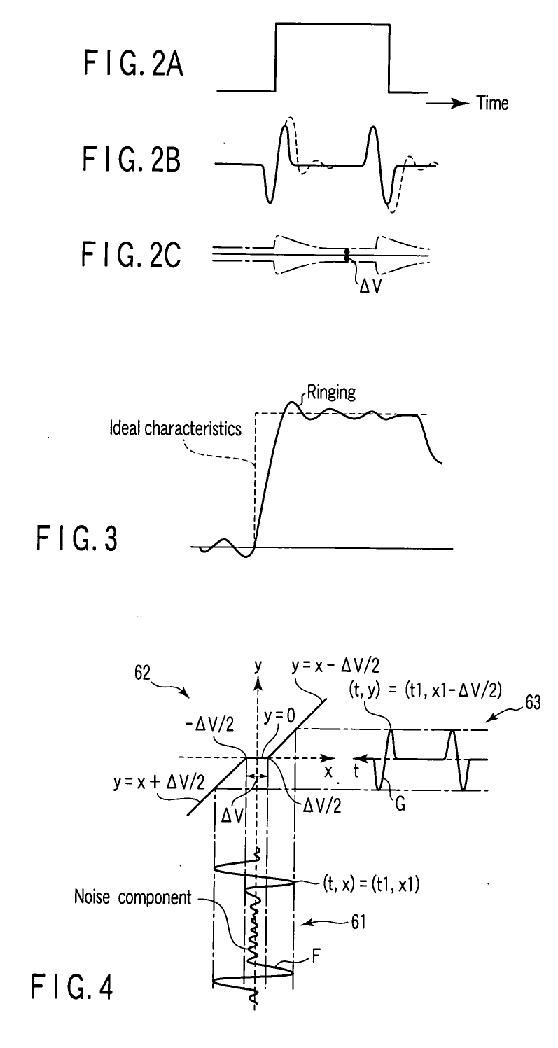

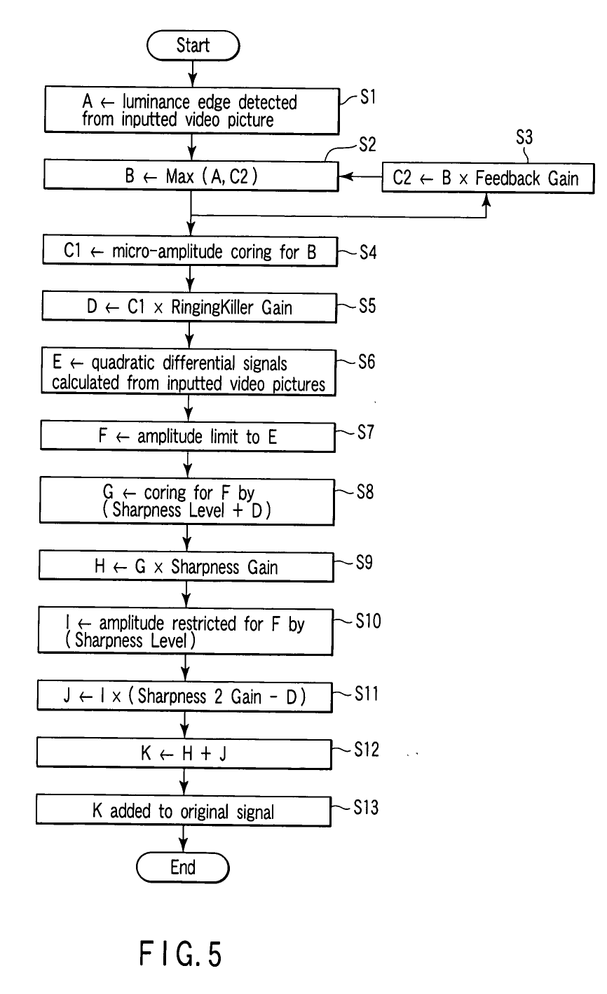

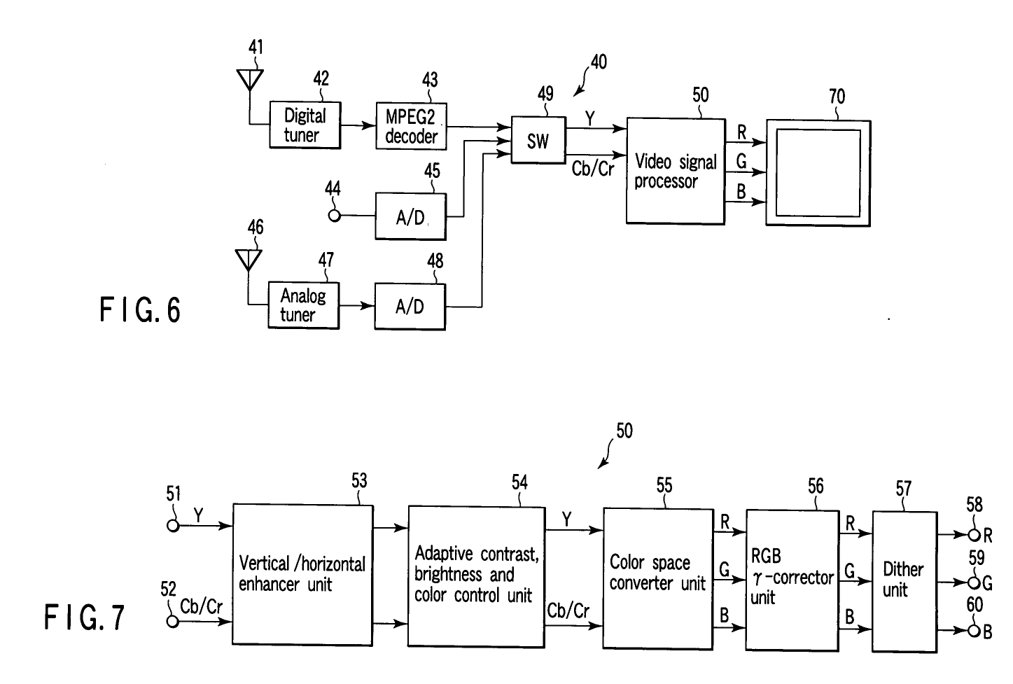

Referring now to drawings, one embodiment according to the present invention will be described in detail as follows. FIG. 1 is a block diagram that shows a video signal processor of one embodiment according to the present invention, FIGS. 2 to 4 are illustrations that explain the action of the processor of FIG. 1, FIG. 5 is a flow chart when a system equivalent to FIG. 1 is achieved by software, FIG. 6 is a block diagram that shows a TV broadcasting receiver to which a video signal processor according to the present invention is applied, and FIG. 7 is a block diagram that shows a configuration of the video signal processor in FIG. 6.

First of all, description will be made on FIG. 6 and FIG. 7.

The TV broadcasting receiver shown in FIG. 6 is a TV receiver, which can receive digital broadcasting and analog broadcasting. The digital TV signals received by a digital TV (television) receiver antenna 41 are received by a digital tuner 42 and demodulated to MPEG2 signal; then, this MPEG2 signal is decoded by an MPEG2 decoder 43 and is outputted as luminance signal Y and color signal Cb/Cr.

In addition, the analog TV signal received by an analog TV receiver antenna 46 is received by an analog tuner 47 and demodulated to luminance signal Y and color signal Cb/Cr; then, this demodulated signal is supplied to an A/D converter unit 48 and outputted as digital luminance signal Y and color signal Cb/Cr.

On the other hand, Y/C separation signal and component signal inputted in an external input terminal 44 and reproduced by an external devices such as VTR, DVD recorder not illustrated are supplied to an A/D converter unit 48, and outputted as digital luminance signal Y and color signal Cb/Cr.

Three luminance signals Y and color signals Cb/Cr outputted from a MPEG2 decoder 43 and A/D converter unit 45, 48 are supplied to three input terminals of switch unit (abbreviated as SW) as a video picture selector circuit, and at the switch unit 49, any one of the input signals is selected on the basis of the selecting operation by the user.

The luminance signal Y and color signal Cb/Cr selected at the switch unit 49 are signal-processed at a video signal processor 50, outputted as R, G, B signals, and displayed on a screen of a digital display device as an output device. For the digital display device 70, LCD displays, plasma displays, and other flat panels are used.

The video signal processor 50 comprises a vertical/horizontal enhancer unit 53 to which luminance signal Y and color signal Cb/Cr are inputted as shown in FIG. 7 and which carries out enhancer processing to make the rising edge of those signals steep or vary sharpness, an adaptive contrast, brightness and color control unit 54 which carries out γ-correction of luminance signal Y and color signal amplitude control associated with its γ-correction, color space converter unit 55 that converts luminance signal Y and color signal Cb/Cr into R, G, B signals, RGB γ-corrector unit 56 which carries out γ-correction of R, G, B signals and adjusts white balance for the output device, and a dither unit 57 which carries out compression processing to convert high-gradation bit expressions with the number of bits expanded to enhance expression power in the preceding stage into the low-gradation number of bits which meets an output device of the subsequent stage.

In following FIGS. 1 to 5 of one embodiment of the present invention, discussion will be made on a horizontal contour correction circuit used for the vertical/horizontal enhancer unit 53 in the video signal processor 50. In the horizontal contour correction circuit described here, influences of ringing components generated when horizontal contour correction signals are generated are intended to be removed.

In FIG. 1, the vertical/horizontal enhancer unit 53 in the video signal processor 50 a ringing detector unit 27 that detects ringing components of video signals inputted in an input terminal 1 and outputs the detection result as a ringing removal control signal 11, a coring value generator unit 28 that generates a coring value set in accordance with changes of the detected ringing component, a contour correction signal generator unit 29 that calculates quadratic differential signals from video signals inputted into the input terminal 1, carries out non-linear processing on the calculated quadratic differential signals including amplitude restriction, coring, and gain adjustment, and generates contour correction signals, and carries out the coring by the coring value from the coring value generator unit 28, and a addition circuit 25 as an output circuit that adds the generated contour correction signals to video signals to be inputted the input terminal 1 and outputs contour-corrected video signals. The coring value generator unit 28 generates a coring value that varies as if it goes along the changes of ringing components detected by the ringing detector unit 27.

In addition to the above-mentioned configuration, the video signal processor further comprises a coring area noise component removing signal generator unit 30 that generates noise component removal signals 23 to remove noise components of the coring area from the video signals inputted by inputting the quadratic differential signals from a quadratic differential calculating circuit 2, restricting the amplitudes of the quadratic differential signals to the level below the coring value to give micro-signals, and inversion-adding this differential signals to the contour correction signals or the video signals inputted into the input terminal 1.

The coring area noise component removing signal generator unit 30 comprises a limit circuit 14 that inputs the quadratic differential signals and limits the amplitudes of the quadratic differential signals to a level below the coring value of the coring circuit 13 to give micro-signals, a multiplier circuit 19 that multiplies negative gains that correspond to ringing components detected by the ringing detector unit 27 by the microsignals, and an addition circuit 24 that adds microsignals multiplied by negative gains by the multiplier circuit 19 as noise component removal signals 23 to the contour correction signals or the video signals inputted. By the way, it may be configured to eliminate the addition circuit 24, input the noise component removal signal 23 in the addition circuit 25, and three signals are added in the addition circuit 25, or to move the addition circuit 24 and dispose it on the output side of the addition circuit 25.

Furthermore, the video signal processor has a control unit 31 that controls a control unit that composes each of the ringing detector unit 27, contour correction signal generator unit 29, and coring area noise component removal signal generator unit 30, and that supplies Nos. 1 to 5 gain coefficients to this circuit unit. For control unit 31, for example, a microprocessor is used.

The contour correction signal generator unit 29 comprises a quadratic differential calculation circuit 2 that calculates quadratic differential signals from the video signals inputted into the input terminal 1, a first limit circuit (abbreviated as LIM) 12 that restricts amplitudes in order not to carry out contour correction to large signal amplitudes for the quadratic differential signals, a first coring circuit 13 that inputs signals from this first limit circuit 12, controls the coring values by the ringing removal control signal 11, and carries out coring to prevent influences such as noise on microsignal amplitudes for signals inputted from the first limit circuit 12, and a first multiplier circuit 17 that adjusts gains set by the first gain coefficient 18 for the output signals from the first coring circuit 13 and outputs as contour correction signals. For the quadratic differential calculating circuit 2, for example, a combination of band pas filters is used.

On the other hand, the ringing detector unit 27 comprises a luminance edge detecting circuit 3 that detects the edge to the luminance of the video signals inputted to the input terminal 1, a maximum value comparing circuit 4 that inputs an edge level detected by the luminance edge detecting circuit 3 into one input end, inputs the former edge level to the other input end, compares both entries, and outputs the difference, and also that has a feedback loop to output the maximum level when the edge is detected, feed this back to the other input end by a feedback gain 7 that sets an appropriate attenuation level using a multiplying circuit 6, and at the same time, sample-holds pixel by pixel by a delay circuit 5 at the time of feedback to the other input end, and peak-holds it and feeds it back in the event that the hold value is on the signal level exceeding a predetermined level, a second coring circuit 8 that carries out coring to removed unwanted components for the differential signals outputted from the maximum value comparing circuit 4, and a multiplier circuit 9 that inputs output signals from the second coring circuit 8, multiplies them by a predetermined gain coefficient 10, and output the multiplication results as ringing removal control signal 11.

Next discussion will be made on the operation of the equipment configured as shown in FIG. 1.

In the contour correction signal generator unit 29 and the coring area noise component removal signal generator unit 30, from video signals inputted in the input terminal 1, the quadratic differential signals are calculated by the quadratic differential calculating circuit 2, and amplitude restriction is carried out on large signal amplitudes by the limit circuit 12 in order not to carry out contour correction; then, here, the signal amplitude is divided into two paths in accordance with the levels set by the use of a sharpness level 16, which is the second gain coefficient.

That is, the first path that carries out gain adjustment set by the sharpness 1 gain 18, which is the first gain coefficient by the coring circuit 13 followed by a multiplying circuit 17 in order to prevent influences from being exerted on microsignal amplitudes such as noise and the second path that adjusts gains set by the use of the sharpness 2 gain 21 which is the third gain coefficient by the use of the multiplying circuit 19 after carrying out amplitude restriction by the limit circuit in order to determine action of the microsignal area.

Signals 22, 23 obtained by these two paths are added by the adding circuit 24, and this added signal is further added by the adding circuit 25 to the input video signal from the input terminal 1, which is the original signal, and contour-corrected video signals are outputted to the output terminal 26. The coring area noise component removal signal 23 obtained signal in the second path is the signal to be inversion-added to the input video signal from the input terminal 1, and this can obtain noise compression effects in the coring area.

In the ringing detector unit 27, the edge to the luminance of video signals inputted in the input terminal 1 is detected by the luminance edge detecting circuit 3 and the detection level is compared with the previous edge level by the maximum value comparing circuit 4. In the event that the rising edge is detected by the luminance edge detecting circuit 3, the differential signal which is the comparison result of the maximum value comparing circuit 4 achieves the maximum level, but it is fed back to one input end of the maximum value comparing circuit 4 as the previous edge level, and by setting the feedback gain 7 which is the fourth gain coefficient to be a value equal to or smaller than 1, thereby, the feedback signal gain-controlled by it in the multiplying circuit 6 has a difference taken from the edge detection signal from the luminance edge detecting circuit 3, and is outputted from the maximum value comparing circuit 4 as a ringing detection signal which is maximized at the ringing generation initiation point (edge initiation point) and gradually attenuates from it. This ringing detection signal has unwanted noise components cored in the coring circuit 8 of the latter stage, and furthermore, is multiplied by a ringingkiller gain 10, which is the fifth gain coefficient in the multiplying circuit 9, and has the amplitude adjusted, and is outputted as ringing removal control signal 11 that corresponds to changes in the ringing component.

When a ringing component is detected from input video signals at the ringing detector unit 27, the ringing removal control signal 11 as a detection result is inputted in the adding circuit 15, increasing the coring value to the coring circuit 13 set by the sharpness level 16, which is the second gain coefficient. Thereby, the coring component is removed in the coring circuit 13, this works on the ringing component generated behind the luminance edge to weaken the enhancing action by contour correction or to prevent enhancing action from being applied.

Furthermore, the ringing removal control signal 11 is inputted in the adding circuit 20 and decreases the gain adjustment value to micro-amplitude area set by the sharpness 2 gain 21 by the third gain coefficient. As a result, the gain to be multiplied by microsignals amplitude-restricted by limit circuit 14 in the multiplying circuit 19 is lowered to a negative gain. In such event, expanding the width of a value set by the sharpness 2 gain 21 to a negative value (for example, −1) results in constantly inversion-addition with respect to the amplitude of the original signal, and works on to the direction to cancel the amplitude level of microsignal of the coring area. By combining the above two effects, when the ringing component is detected, it is possible to weaken or remove the ringing components.

According to one embodiment of the present invention, an edge detecting circuit 3 and a horizontal contour compensating circuit for luminance signals of video signal inputted are equipped, and in the contour correction signal generator unit 29, it is possible to increase the ringing removal effects by increasing the coring value to the coring circuit 13 that cuts the level below the predetermined amplitude of quadratic differential signal of the horizontal contour correction circuit when the edge of luminance signal which serves as an initiation point of ringing generation, and at the same time, by degrading the gain characteristics for quadratic differential signals which are smaller than the coring value, providing a negative gain, and inversion-adding, it becomes possible to remove noise components of micro-amplitude when ringing occurs from the original input video signals.

Furthermore, in the ringing detector unit 27, since the peak-hold is carried out by attenuating from the ringing generation initiation point when the comparison results of edge level by the maximum value comparison circuit 4, unless the edge level is detected, ringing removal effects by peak-hole are gradually decreased in such a manner as to converge to zero, and the ringing removal control signal no longer works. By this, it becomes possible to maintain the contour correction effects for the small signal amplitude other than the ringing component generated after the large signal amplitude.

In addition, according to one embodiment of the present invention, parameter control by gain control is adopted, and therefore, it becomes possible to achieve a video signal processor, which is suited for integrated circuits, particularly, LSIs.

FIG. 2A indicates the waveform of input video signals and the solid line of FIG. 2B indicates the waveform of quadratic differential signal obtained by quadratically differentiating the input video signals of FIG. 2A, respectively. The dotted line of FIG. 2B indicates the waveform of quadratic differential signal affected by ringing shown in FIG. 3. With respect to coring ΔV, description will be made later referring to FIG. 4. FIG. 2C indicates changes of coring value ΔV generated in such a manner as to remove the ringing (dotted line) of FIG. 2B. The vertical level parallel to the centerline of the coring value ΔV in FIG. 2C corresponds to the coring value to remove the noise component (see FIG. 4), and the protruded portion, which has a smooth skirt shape gradient that exceeds the line of the parallel vertical level, corresponds to the coring value that removes the ringing component.

As shown in FIG. 3, ringing is the vibration generated at the waveform rising portion by transient phenomenon in an electronic circuit and the amplitude is large at the ringing generation initiation point and is gradually attenuated and finally reaches zero amplitude as time passes. In the event that this ringing phenomenon occurs in the video signal processor, vibratile stripes (black and white) are formed at the edge portion of video picture displayed on a screen of the display device (signal level is from black to white or from white to black).

FIG. 4 is an illustration that indicates coring characteristics of the coring circuit 13 (or 8) of FIG. 1.

The graph 61 shows quadratic differential signal F inputted into the coring circuit 13, graph 62 coring characteristics of the coring circuit 13, and graph 63 the output signal G outputted from the coring circuit 13. Graph 61 takes time t as ordinate and has its abscissa used jointly as the abscissa of graph 62. Graph 62 takes level y of output signal G as ordinate and the level x of quadratic differential signal as abscissa. Graph 63 has ordinate shared with ordinate of graph 62 and takes time t as abscissa.

In the quadratic differential signal inputted in the coring circuit 13, the noise component provides characteristics of comparatively small amplitudes, while the edge of video signal by the video contour as well as high-region component of original video picture by accurate portion of video picture provide comparatively large amplitudes. On the other hand, ringing provides the amplitude comparatively larger than the noise component for a predetermined period from the ringing generation initiation point. Consequently, in order to remove the noise component, the coring characteristics of coring circuit 13 are set with the area ΔV (−ΔV/2≦x≦ΔV/2), which slightly exceeds the noise component of level x of the quadratic differential signal inputted, designated as the above-mentioned coring value ΔV, and in this area ΔV, it is set in such a manner that the level of the output signal G to be outputted shall be y=0.

The coring characteristics of the coring circuit 13 is set in such a manner that the level y becomes y=x−ΔV/2 in the area with a larger level x than the area ΔV (ΔV/2<x). To explain the conversion from quadratic differential signal to the output signal G in such event by taking the vertex of quadratic differential signal (t, x)=(t1, x1) for an example, at the time t=t1, when the quadratic differential signal is located at the level x=x1, by the coring characteristics of the coring circuit 13, the level y of the output signal G becomes x1−ΔV/2. By this, the vertex of quadratic differential signal (t, x)=(t1, x1) corresponds to the vertex of output signal G (t, y)=(t1, x1−ΔV/2) by the coring circuit 13.

Furthermore, the coring characteristics of coring circuit 13 are set in such a manner that the level y becomes y=x+ΔV/2 in an area where the level x is smaller than the area ΔV (−ΔV/2>x).

By this kind of setting, the quadratic differential signal inputted from the coring circuit 13 is cored (core-removing) by the coring value ΔV, and the core-removed portion becomes the output signal G compressed to zero (0) amplitude. By this, the output signal G has the noise component with small amplitude removed.

In the above-mentioned coring circuit 13, the coring value ΔV of the coring circuit 13 is set to be large in the event that it is desired to increase noise reduction effects and the coring value ΔV of the coring circuit 13 is set to be small in the event that it is desired to increase the screen resolution.

Furthermore, in order to remove the ringing component, when the luminance edge, the initiation point of ringing generation, is detected, based on the ringing removal control signal 11 from the ringing detector unit 27, during a predetermined period while influences of ringing (presence of ringing vibration) are exerted from the edge detection point, the coring value ΔV to cut the noise component below the predetermined amplitude of the quadratic differential signal of the contour correction signal generator unit 29 is operated in the direction to increase during the period only and the ringing component is weakened or removed.

FIG. 5 indicates a flow chart when a system equivalent to FIG. 1 is achieved by software. Reference symbols A to K correspond to signals of each unit in FIG. 1.

First of all, in the ringing detection processing, the luminance edge is detected from the inputted video signal, and with the edge detection signal designated as A (Step S1), the edge detection signal A is compared with the previous edge level in the maximum value comparison processing and the differential signal is designated as B (Step S2). The differential signal B is multiplied by the feedback gain 7, sample-held, designated as C2 (Step S3), and again compared with the next edge level in the maximum value comparison processing.

The differential signal B, which is the comparison output of the maximum value comparison processing, undergoes minimum amplitude coring by coring processing and is designated as C1 (Step S4). C1, which is the output of coring processing is multiplied by ringingkiller gain 10 and the multiplication result, is designated as D (Step S5).

Then, in contour correction generation processing, from the inputted video signal, the quadratic differential signal is calculated and the quadratic differential signal is designated as E (Step S6). And the quadratic differential signal E is amplitude-limited by limit processing and is designated as F (Step S7).

For the amplitude-limited quadratic differential signal F, coring processing is provided with the sum of the sharpness level 16 and signal level D multiplied by the ringingkiller gain 10 used as the coring value and the coring-processed quadratic differential signal is designated as G (Step S8). The quadratic differential signal G is multiplied by sharpness 1 gain 18 and the multiplication result is designated as H (Step S9).

On the other hand, the amplitude-limited quadratic differential signal F is further amplitude-limited by the sharpness level 16, and this is designated as signal I (Step S10). The signal I is multiplied by the difference between the sharpness 2 gain 21 and the signal level D multiplied by the ringingkiller gain 10 and is designated as signal J (Step S11).

The signal H multiplied by the sharpness 1 gain 18 and the signal J are added and the sum is designated as the horizontal contour correction signal K (Step S12). The contour correction signal K is added to the original input video signal (Step S13) and the horizontal-contour-corrected video signal is obtained.

This invention is effective when it is applied to all integrated circuit implementation, particularly, LSI implementation of video signal processors such as picture quality correcting circuit where ringing is the problem. Consequently, it is useful when it is applied to video equipment including TV receivers and video signal recorders and reproducers, which include video signal processing.

By the way, the present invention shall not be limited to the above-mentioned embodiments as they are but in the working stages, the invention may be embodied by changing the component elements in various forms without departing from the spirit and scope thereof. In addition, by properly combining multiple component elements disclosed in the above-mentioned embodiments, various inventions may be formed. For example, from all the component elements shown in embodiments, several component elements may be deleted. Furthermore, component elements related to different embodiments may be properly combined.

What is claimed is:

1. A video signal processor comprising:
a ringing detector unit configured to detect ringing components of video signals inputted;
a coring value generator unit configured to generate a coring value in accordance with changes of ringing components detected at the ringing detector unit;
a contour correction signal generator unit which generates contour correction signals by calculating quadratic differential signals from the video signals inputted, carrying out nonlinear processing including restricting amplitudes, coring and gain adjustment to the calculated quadratic differential signals and is configured to carry out the coring by the coring value from the coring value generator unit; and
an output unit configured to output the contour correction signals generated in the contour correction signal generator unit by adding them to the video signals inputted.

2. The video signal processor according to claim 1, further comprising
a coring area noise component removing signal generator unit configured to generate noise component removal signals to remove noise components of the coring area from the video signals inputted by inputting the quadratic differential signals, restricting the amplitudes of the quadratic differential signals to the level below the coring value to give micro-signals, and inversion-adding this differential signals to the contour correction signals or the video signals inputted.

3. The video signal processor according to claim 2, wherein
the coring area noise component removal signal generator unit comprises:
a limit circuit configured to input the quadratic differential signals and limit the amplitudes of the quadratic differential signals to a level below the coring value to give micro-signals;
a multiplier circuit configured to multiply negative gains which correspond to ringing components detected by the ringing detector unit by the microsignals; and
an addition circuit configured to add microsignals multiplied by negative gains by the multiplier circuit as noise component removal signals to the contour correction signals or the video signals inputted.

4. The video signal processor according to claim 1, wherein
the contour correction signal generator unit comprises
a quadratic differential calculation circuit configured to calculate quadratic differential signals from the video signals inputted,
a first limit circuit configured to restrict amplitudes in order not to carry out contour correction to large signal amplitudes for the quadratic differential signals,
a first coring circuit configured to control coring values by the ringing components from the ringing detector unit and carry out coring to prevent influences such as noise on microsignal amplitudes for signals inputted from the first limit circuit, and
a first multiplier circuit configured to adjust gains set by the first gain coefficient to the output signals from the first coring circuit and output as contour correction signals.

5. The video signal processor according to claim 1, wherein
the ringing detector unit comprises
a luminance edge detecting circuit configured to detect the edge to the luminance of the video signals inputted,
a maximum value comparing circuit configured to input an edge level detected by the luminance edge detecting circuit into one input end, input the previous edge level to the other input end, compare both entries, and outputs the difference, and also configured to have a feedback loop to output the maximum level when the edge is detected, feed this back to the other input end by a feedback gain which sets an appropriate attenuation level, and at the same time, sample-hold pixel by pixel at the time of feedback to the other input end, and peak-hold it and feed it back in the event that the hold value is on the signal level exceeding a predetermined level,
a second coring circuit configured to carry out coring to removed unwanted components for the differential signals outputted from the maximum value comparing circuit, and
a multiplier circuit configured to input output signals from the second coring circuit, multiply them by a predetermined gain coefficient, and output the multiplication results as ringing components.

6. The video signal processor according to claim 1, wherein
the coring value generator unit is equipped with an adding circuit configured to add ringing components detected by the ringing detector unit to a predetermined gain coefficient and generate the addition value as a coring value.

7. A video signal processing method, comprising:
a ringing detection step of detecting ringing components of video signals inputted;
a coring value generation step of generating a coring value in accordance with the ringing components detected;
a contour correction signal generating step of generating contour correction signals by calculating quadratic differential signals from the video signals inputted, carrying out nonlinear processing including restricting amplitudes, coring and gain adjustment for the calculated quadratic differential signals the coring being carried out by the coring value generated in the coring value generating step; and
an output step of adding the contour correction signal generated to the video signals inputted and outputting the added signals.

8. The video signal processing method according to claim 7, further comprising
a coring area noise component removal signal generating step of generating noise component removal signals to remove noise components in the coring area from the video signals inputted by inputting the quadratic differential signals, restricting the amplitudes of the quadratic differential signals to be below the coring value to give a microsignal, and inversion-adding the microsignal to the contour correction signals or video signals inputted.

9. The video signal processing method according to claim 8, wherein
the coring area noise component removal signal generating step comprises:
a limit step of inputting the quadratic differential signals and limiting the amplitudes of the quadratic differential signals to be below the coring value to give a microsignal;
a multiplying step of multiplying a negative gain which corresponds to the ringing component detected in the ringing detecting step by the microsignal; and
an adding step of adding the microsignal multiplied by the negative gain by the multiplying step as a noise component removal signal to the contour correction signal or the video signal inputted.

10. The video signal processing method according to claim 7, wherein
the contour correction signal generating step comprises:
a quadratic differential calculating step of calculating the quadratic differential signal from the video signals inputted;
a first limit step of limiting amplitudes for the quadratic differential signal not to carry out contour correction to large signal amplitudes;
a first coring step of carrying out coring for the signals whose coring value is controlled by the ringing components from the ringing detecting step and obtained by the first limit step in order to prevent influences from being exerted on microsignal amplitudes; and
a first multiplying step of carrying out gain adjustment set by the first gain coefficient for the signals obtained by the first coring step and outputting as contour correction signals.

11. A TV broadcasting receiving unit comprising:
a receiver unit configured to receive TV broadcasting and demodulate it to video signals;
a ringing detector unit configured to detect ringing components of video signals obtained by the receiver unit;
a coring value generator unit configured to generate a coring value in accordance with changes in ringing components detected by the ringing detector unit;
a contour correction signal generator unit which generates contour correction signals by calculating the quadratic differential signals from the video signals obtained by the receiver unit, and carrying out nonlinear processing including restricting amplitudes, coring and gain adjustment for the calculated quadratic differential signals and is configured to carry out the coring by the coring value from the coring value generator unit;
an output unit configured to add the contour correction signals generated by the contour correction signal generator unit to the video signals obtained by the receiver unit and output the added signals; and
a display unit configured to display video signals outputted from the output unit.
